(19) United States
(12) Patent Application Publication
(10) Pub. No.: US 2010/0033139 A1
(43) Pub. Date: Feb. 11, 2010

(54) POWER ADAPTER FOR BATTERY CHARGER AND METHOD THEREOF

(75) Inventor: WEI-PENG AN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (TW); HON HAI PRECISION INDUSTRY CO., LTD., Tu-Cheng (TW)

(21) Appl. No.: 12/501,497

(22) Filed: Jul. 13, 2009

(30) Foreign Application Priority Data
Aug. 11, 2008 (CN) 200810303663.5

(51) Int. Cl. H02J 7/06; H02J 7/04

(52) U.S. Cl. 320/163; 320/162

(57) ABSTRACT

A power adapter includes a charging unit configured to charge a rechargeable battery, a sensing unit configured to detect the voltage of the rechargeable battery, a switch unit connected between the external power source and the charging unit, and a control unit. The control unit is configured to compare the detected voltage with a fully-charged reference voltage which is provided for indicating the rechargeable battery is fully-charged during the charging process, and control the switch unit to turn on if the detected voltage is lower than the fully-charged reference voltage and control the switch unit to turn off if the detected voltage is equal to or higher than the fully-charged reference voltage. When the switch unit is turned on, the charging unit charges the rechargeable battery. When the switch unit is turned off, the charging unit stops charging the rechargeable battery.

### BACKGROUND

1. Technical Field

The disclosure relates to battery chargers and, particularly, to a power adapter for charging rechargeable batteries and a method thereof.

2. Description of Related Art

Nowadays, electronic devices such as mobile phones and media players are more and more popular. Some electronic devices use rechargeable batteries as a power source, and therefore need power adapters to charge the rechargeable batteries, which is convenient and effective. However, people often forget to remove the power source when the rechargeable batteries are fully charged or will purposely keep it connected to maintain the charge while they use the electronic devices. Although the power adapter may charge the rechargeable batteries with small current when the rechargeable batteries are fully charged, power is still wasted.

Therefore, it is necessary to provide a power adapter and a method to overcome the above-identified deficiencies.

### BRIEF DESCRIPTION OF THE DRAWINGS

The components in the drawings are not necessarily drawn to scale, the emphasis instead being placed upon clearly illustrating the principles of the power adapter. Moreover, in the drawings, like reference numerals designate corresponding parts throughout the several views.

FIG. 1 is a block diagram showing a power adapter in accordance with an exemplary embodiment.

FIG. 2 is a flowchart illustrating an exemplary method for charging battery in accordance with an exemplary embodiment.

### DETAILED DESCRIPTION

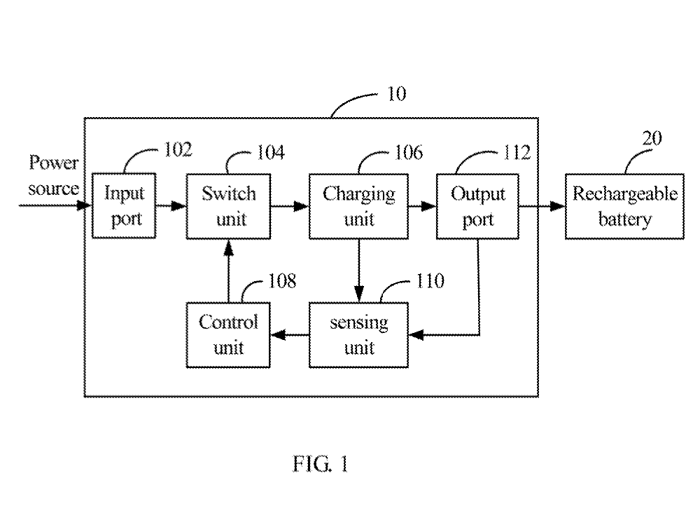

Referring to FIG. 1, a power adapter 10, includes an input port 102, a switch unit 104, a charging unit 106, a control unit 108, a sensing unit 110, and an output port 112. The power adapter 10 is used to charge a rechargeable battery 20.

The input port 102 is configured to connect the power adapter 10 to an external power source, such as an alternating current power source. The charging unit 106 is configured to convert the alternating current into direct current and charge the rechargeable battery 20. The switch unit 104 is connected between the input port 102 and the charging unit 106, and is configured to establish or cut off the connection between the charging unit 106 and the external power source. The output port 112 is configured to output power from the charging unit 106 to the rechargeable battery 20.

The sensing unit 110 is connected to the output port 112, and is configured to detect the voltage of the rechargeable battery 20. The control unit 108 is connected both to the sensing unit 110 and the switch unit 104, and is configured for comparing the detected voltage with a predetermined voltage and controlling the switch unit 104 to turn on or off according to the comparing result.

In the initial state before the power adapter 10 is connected to the external power source and the rechargeable battery 20, the switch unit 104 is at an off state, namely, the switch unit 104 has been turned off. When the adapter 10 is connected to the external power source and the rechargeable battery 20, the sensing unit 110 detects the voltage of the rechargeable battery 20. The control unit 108 compares the detected voltage with a threshold reference voltage, if the detected voltage is equal to or higher than the threshold reference voltage, the control unit 108 does nothing to the switch unit 104 and the switch unit 104 remains off, thus to prevent power being fed to the rechargeable battery 20. If the detected voltage is lower than the threshold reference voltage, the control unit 108 controls the switch unit 104 to turn on. The charging unit 106 receives the power from the external power source and starts to charge the rechargeable battery 20. In the exemplary embodiment, the threshold reference voltage is the minimum voltage at which the rechargeable battery 20 is capable of maintaining the normal work of an electronic device powered by the rechargeable battery 20. If the voltage of the rechargeable battery 20 is equal to or higher than the threshold reference voltage, the adapter 10 is prevented from charging the rechargeable battery 20, thus to avoid frequent charging of the rechargeable battery 20 which could reduce the life of the rechargeable battery 20. Once a charging process is initiated, the threshold reference voltage is not used during the process, instead, a fully-charged reference voltage is used, which is explained below.

The sensing unit 110 also detects the voltage of the rechargeable battery 20 during the charging process. The control unit 108 compares the detected voltage with a fully-charged reference voltage which indicates a full charge state of the rechargeable battery 20, if the detected voltage is lower than the fully-charged reference voltage, the control unit 108 controls the switch unit 104 to remain on and the charging unit 106 continues to charge the rechargeable battery 20. If the detected voltage is equal to or higher than the fully-charged reference voltage, the control unit 108 controls the switch unit 104 to turn off. The connection between the charging unit 106 and the external power source is cut off, and the charging unit 106 stops providing power to the rechargeable battery 20.

The switch unit 104 can be a metal-oxide-semiconductor field-effect transistor (MOSFET), a bipolar junction transistor (BJT), or the like. In the embodiment, the sensing unit 110 is a transducer.

Therefore, the power adapter 10 in the exemplary embodiment is capable of detecting the voltage of the rechargeable battery 20 and charging the rechargeable battery 20 only when the voltage of the rechargeable battery 20 is lower than the threshold reference voltage. The power adapter 10 also timely stops charging the rechargeable battery 20 once the rechargeable battery 20 is fully charged thus avoiding wasting power and possibly damaging the rechargeable battery 20.

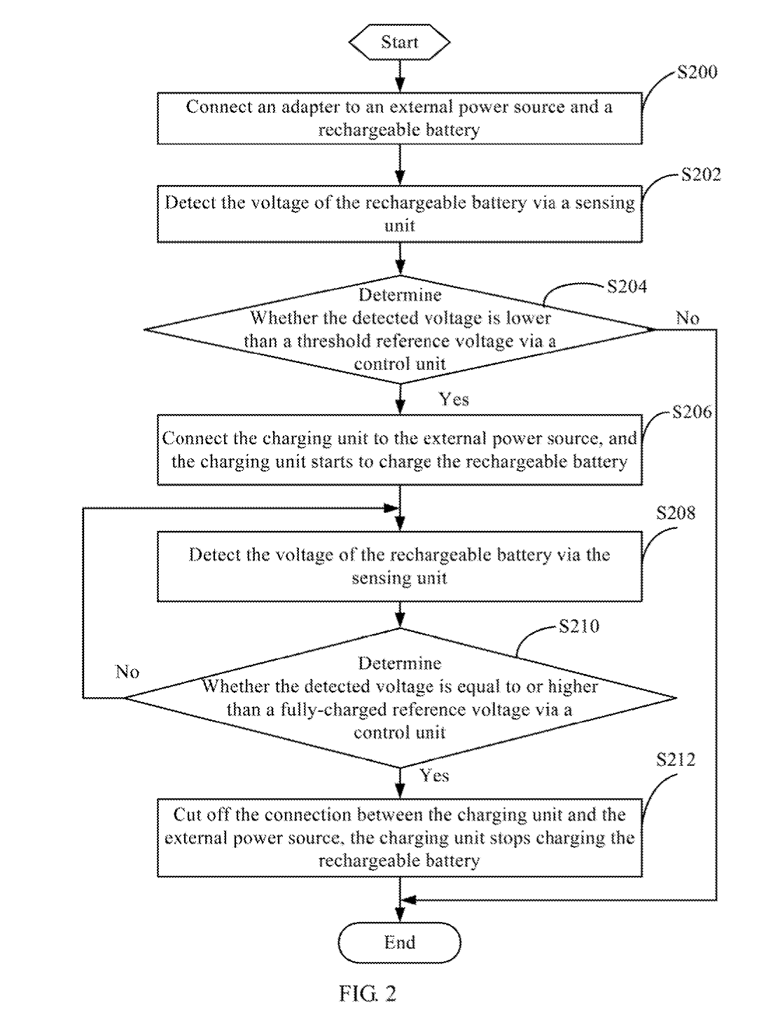

FIG. 2 is a flowchart illustrating a method for charging a rechargeable battery. In step S200, the power adapter 10 is connected to an external power source and the rechargeable battery 20.

In step S202, the sensing unit 110 detects the voltage of the rechargeable battery 20.

In step S204, the control unit 108 compares the detected voltage with a threshold reference voltage and determines whether the detected voltage is lower than the threshold reference voltage.

If the detected voltage is not lower than the threshold reference voltage, namely the detected voltage is equal to or higher than the threshold reference voltage, the process ends, otherwise, in step S206, the control unit 108 controls the switch unit 104 to turn on to establish the connection between the external power source and the charging unit 106, and the charging unit 106 begins charging the rechargeable battery 20.

In step S208, the sensing unit 110 detects the voltage of the rechargeable battery 20.

In step S210, the control unit 108 compares the detected voltage with a fully-charged reference voltage of the rechargeable battery 20.

If the detected voltage is not equal to or higher than the fully-charged reference voltage, namely the detected voltage is lower than the fully-charged reference voltage, the process goes back to step S208, otherwise, in step S212, the control unit 108 controls the switch unit 104 to cut off the connection between the external power source and the charging unit 106, and the charging unit 106 stops charging the rechargeable battery 20.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A power adapter, comprising:
an input port configured for connecting the power adapter to an external power source;
a charging unit configured for charging a rechargeable battery with power from the external power source;
an output port configured for connecting the power adapter to the rechargeable battery;
a switch unit connected between the input port and the charging unit for establishing or cutting off a connection between the input port and the charging unit;
a sensing unit configured for detecting the voltage of the rechargeable battery; and
a control unit connected between the sensing unit and the switch unit, and configured for comparing the detected voltage with a fully-charged reference voltage which indicating the rechargeable battery is fully-charged during the charging process and controlling the switch unit to turn off to cut off the connection between the input port and the charging unit if the detected voltage is equal to or higher than the fully-charged reference voltage.

2. The power adapter of claim 1, wherein the control unit is further configured for keeping the switch unit on when the detected voltage is lower than the fully-charged reference voltage.

3. The power adapter of claim 1, wherein the switch unit is at an off state before the power adapter is connected to the external power source and the rechargeable battery, and the control unit is further configured for comparing the detected voltage with a threshold reference voltage, and controlling the switch unit to turn on only when the detected voltage is lower than the threshold reference voltage.

4. The power adapter of claim 1, wherein the sensing unit is a transducer.

5. The power adapter of claim 1, wherein the switch unit comprises one selected from the group consisting of a MOSFET, and a BJT.

6. A method for charging a rechargeable battery using a power adapter, the power adapter comprising:
a switch unit;
a charging unit;
a control unit, and a sensing unit, the method comprising:
charging the rechargeable battery via the charging unit;
detecting the voltage of the rechargeable battery via the sensing unit;
comparing the detected voltage with a fully-charged reference voltage via the control unit; and
tuning off the switch unit via the control unit when the detected voltage is equal to or higher than the fully-charged reference voltage which is provided for indicating the rechargeable battery is fully-charged during the charging process, thus to cut off a connection between the charging unit and an external power source.

7. The method of claim 6, further comprising steps executed before the charging step:
connecting the power adapter to the external power source and the rechargeable battery;
detecting the voltage of the rechargeable battery via the sensing unit;
comparing the detected voltage with a threshold reference voltage via the control unit; and
turning on the switch unit to establish the connection between the charging unit and the external power source when the detected voltage is lower than the threshold reference voltage.

8. The method of claim 7, further comprising:
maintaining the switch unit at the off state when the detected voltage is equal to or higher than the threshold reference voltage.
